(19) United States
(12) Patent Application Publication
(10) Pub. No.: US 2023/0273085 A1
(43) Pub. Date: Aug. 31, 2023

(54) MULTI-AXIS FORCE SENSING DEVICE AND CALIBRATION METHOD THEREOF

(71) Applicant: Coretronic Corporation, Hsin-Chu (TW)

(72) Inventors: Shih-Wei Liu, Hsin-Chu (TW); Kuang-Yao Liu, Hsin-Chu (TW); Ming-Ju Chang, Hsin-Chu (TW); Yung-Yu Chang, Hsin-Chu (TW); Chi-Tang Hsieh, Hsin-Chu (TW)

(73) Assignee: Coretronic Corporation, Hsin-Chu (TW)

(21) Appl. No.: 18/171,389

(22) Filed: Feb. 20, 2023

(30) Foreign Application Priority Data
Feb. 25, 2022 (CN) 202210176387.0

(51) Int. Cl. G01L 19/04; G01L 1/22; G01L 3/14

(52) U.S. Cl. CPC G01L 19/04; G01L 1/2287; G01L 3/1457

(57) ABSTRACT

Provided is a multi-axis force sensing device, including a central portion, an outer ring portion, multiple measurement shafts, and multiple sensing groups. The outer ring portion surrounds the central portion. The measurement shafts are respectively connected between the central portion and the outer ring portion. The measurement shafts are equally disposed on an outer side of the central portion. A first surface and a second surface of each measurement shaft are respectively disposed with one of the sensing groups. Each sensing group includes a first strain sensing element and a second strain sensing element. The first strain sensing element is disposed on a first central line of symmetry on the first surface or on a second central line of symmetry on the second surface. The second strain sensing element is disposed on the first surface or the second surface.

### CROSS-REFERENCE TO RELATED APPLICATION

This application claims the priority benefit of China application serial no. 202210176387.0, filed on Feb. 25, 2022. The entirety of the above-mentioned patent application is hereby incorporated by reference herein and made a part of this specification.

### BACKGROUND

### Technical Field

The disclosure relates to a sensing device and a calibration method thereof, and more particularly to a multi-axis force sensing device and a calibration method corresponding to temperature thereof.

### Description of Related Art

Developments of robots and robotic arms gains increasing significance and high visibility in many fields such as biomedicine, science, aerospace, or industry. In most scenarios of use, a robotic arm or a tool installed on the robotic arm is in contact with an object, and a force/torque sensor installed on the robotic arm in will try to monitor the contact relationship between the robotic arm and the objects and generate force feedback information. With a force feedback information, the robotic arm or the tool can do more delicate work such as assembly, polishing, welding, drilling, mechanical testing, and the like.

The force/torque sensor is a sensor with six degrees of freedom, also known as a 6 DOF or 6-axis force/torque sensor, which can be used force feedback information in various fields. In the robotic arm, the force/torque sensor is usually disposed between an arm and a gripper to measure the force applied by an external object on the gripper, and convert the strain measured by the force and torque sensor into the applied force behavior. The most common way to measure the strain is to use a strain gauge.

The metal strain gauge and the semiconductor strain gauge are two common forms of strain gauges, both deformed together with the attached structures. The deformation leads to a resistance change of the strain gauges, and a bridge is used to measure the voltage difference generated by the resistance change of the strain gauge to obtain the strain. However, the metal strain gauge is less prone to the influence of temperature but has low sensitivity to generated signals, while the semiconductor strain gauge is highly prone to the influence of temperature but has high sensitivity to generated signals Therefore, under the demand of high sensitivity temperature drift is an enormous problem in the use of the semiconductor strain gauge.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a multi-axis force sensing device and a calibration method thereof that may avoid the problem of temperature drift generated by the influence of temperature, thereby improving the accuracy of force measurement.

Other objectives and advantages of the disclosure may be further understood from the technical features disclosed herein.

To achieve one or a part or all of the above or other objectives, the disclosure provides a multi-axis force sensing device, including a central portion, an outer ring portion, multiple measurement shafts, and multiple sensing groups. The outer ring portion surrounds the central portion. The measurement shafts are respectively connected between the central portion and the outer ring portion. The measurement shafts are equally disposed on an outer side of the central portion. A first surface and a second surface of each measurement shaft are respectively disposed with one of the sensing groups. Each sensing group includes a first strain sensing element and a second strain sensing element. The first strain sensing element is disposed on a first central line of symmetry on the first surface or on a second central line of symmetry on the second surface. The second strain sensing element is disposed on the first surface or the second surface.

To achieve one or a part or all of the above or other objectives, the disclosure further provides a calibration method of a multi-axis force sensing device, including the following steps. A multi-axis force sensing device is provided, including multiple measurement shafts and multiple sensing groups disposed on the measurement shafts. Each sensing group includes a first strain sensing element and a second strain sensing element. A calibration force is applied to the sensing groups at a first temperature to obtain first strain data, and the calibration force is applied to the sensing groups at a second temperature to obtain second strain data. A first temperature calibration matrix is obtained according to the first strain data and the calibration force, and a second temperature calibration matrix is obtained according to the second strain data and the calibration force. A calibration coefficient is obtained according to the first temperature calibration matrix and the second temperature calibration matrix. A compensated calibration matrix is obtained according to a first temperature value, a second temperature value, the first temperature calibration matrix, and the calibration coefficient.

Based on the above, embodiments of the disclosure have at least one of the following advantages or effects. In the multi-axis force sensing device and the calibration method thereof in the disclosure, the multi-axis force sensing device includes the measurement shafts and the sensing groups disposed on the measurement shafts, and each sensing group includes the first strain sensing element and the second strain sensing element disposed at different positions. The calibration matrices in different temperatures are obtained by calculating with strain data and force data measured in different temperatures. The calibration coefficient is obtained by interpolating with the calibration matrices in different temperatures and the measured temperatures. Moreover, the compensated calibration matrix is obtained by calculating with the calibration matrices in different temperatures and the calibration coefficient. In this way, putting the compensated calibration matrix into the formula for calibration matrix calculation may effectively compensate and correct signal data of the semiconductor strain gauge, such that the multi-axis force sensing device may avoid the problem of temperature drift generated by the influence of temperature, thereby improving the accuracy of force measurement.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a mechanical arm according to an embodiment of the disclosure.

FIG. 2 is a schematic front view of the multi-axis force sensing device of FIG. 1.

FIG. 3 is a partially enlarged schematic view of the multi-axis force sensing device of FIG. 1.

FIG. 4 is a flow chart of steps of a calibration method of a multi-axis force sensing device according to an embodiment of the disclosure.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

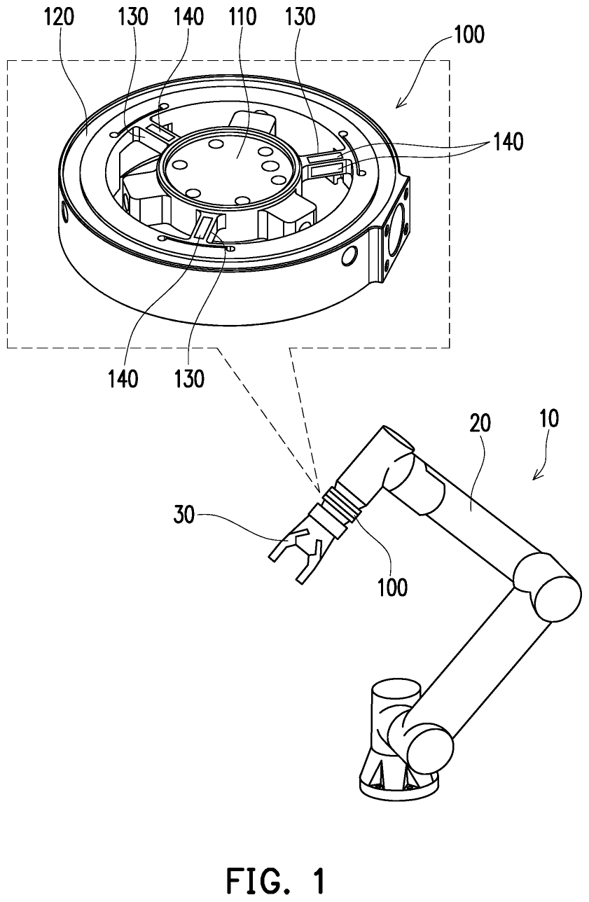

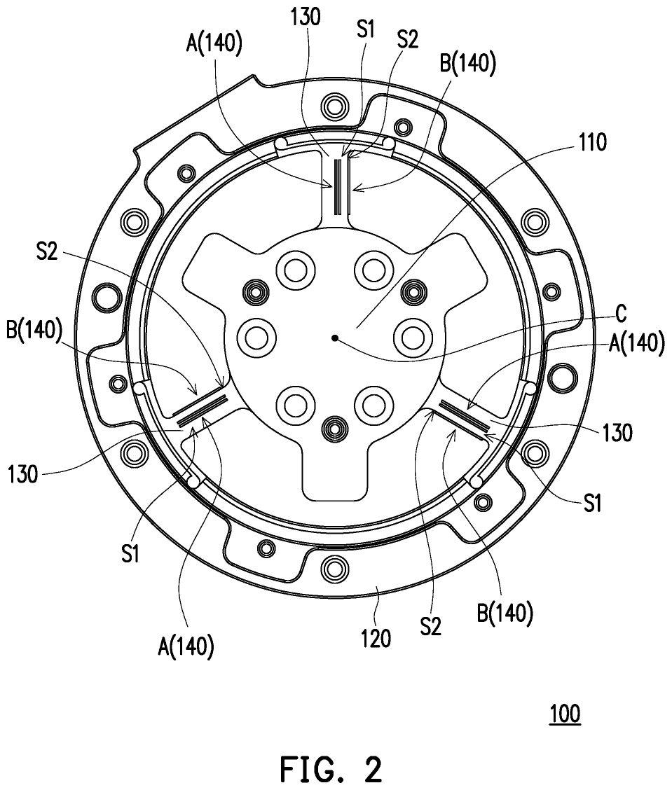

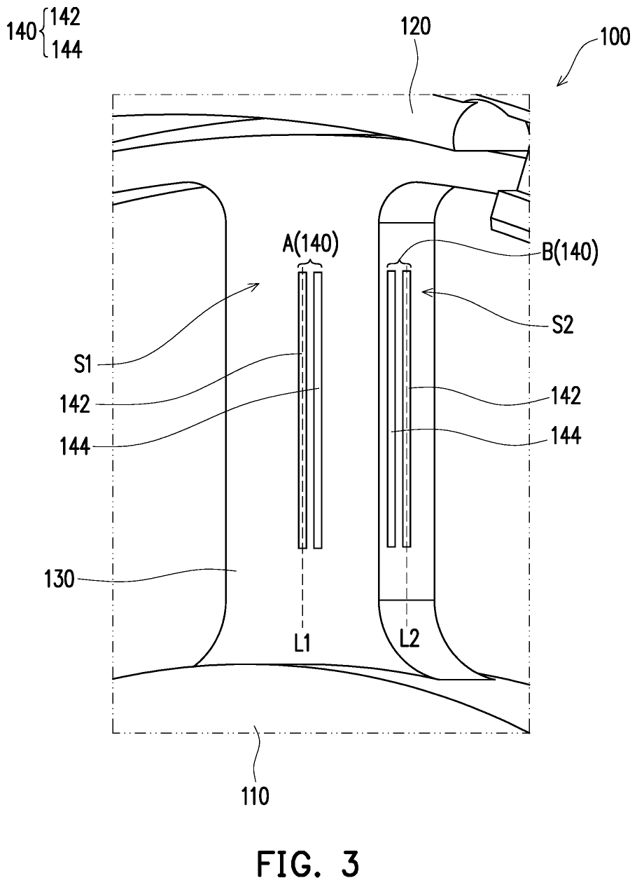

FIG. 1 is a schematic view of a mechanical arm according to an embodiment of the disclosure. FIG. 2 is a schematic front view of the multi-axis force sensing device of FIG. 1. FIG. 3 is a partially enlarged schematic view of the multi-axis force sensing device of FIG. 1. With reference to FIG. 1 to FIG. 3, this embodiment provides a multi-axis force sensing device 100 for force/torque sensing of a mechanical arm 10 to sense the force state of the mechanical arm 10 and obtaining the force state of the mechanical arm 10 according to the sensing result, the mechanical arm 10 can be calibrated according to the sensing results, thereby improving the accuracy of the mechanical arm 10. For example, in this embodiment, the mechanical arm 10 includes an arm portion 20 and a grapper 30 connected to the arm portion 20. During the calibration of the mechanical arm 10, the multi-axis force sensing device 100 is disposed between the arm portion and the grapper 30.

In this embodiment, the multi-axis force sensing device 100 includes a central portion 110, an outer ring portion 120, multiple measurement shafts 130, and multiple sensing groups 140. The outer ring portion 120 surrounds the central portion 110. The measurement shafts 130 are respectively connected between the central portion 110 and the outer ring portion 120, and these measurement shafts 130 are equally and spaced disposed on an outer side of the central portion 110. That is, each of the measurement shafts 130 and the outer side of the central portion 110 has a joint, and the distances between adjacent joints are the same. The number of the measurement shafts 130 is at least three, and the measurement shafts 130 surround the central portion 110 with a central point C of the central portion 110 (the center point of the orthographic projection of the central portion 110 in the front view) as the center of symmetry. In other words, the included angles between adjacent measurement shafts 130 (for example, the included angle between the central axes of the adjacent measurement shafts 130, the central axis is, for example, the connection between the central portion 110 and the outer ring portion 120 through the measurement shafts 130) are all the same. Each measurement shaft 130 includes a first surface S1 and a second surface S2. In this embodiment, the first surface S1 of each measurement shaft 130 is perpendicular to the second surface S2. Furthermore, in this embodiment, the central portion 110, the outer ring portion 120, and the measurement shaft 130 mentioned above are integrally formed, but the disclosure is not limited thereto.

The sensing groups 140 are disposed on at least two different surfaces of the measurement shafts 130. For example, in this embodiment, the first surface S1 and the second surface S2 of each measurement shaft 130 are respectively disposed with one of the sensing groups 140, which means the sensing groups 140 are respectively disposed on the first surfaces S1 and the second surfaces S2 of the measurement shafts 130. Specifically, each sensing group 140 includes a first strain sensing element 142 and a second strain sensing element 144, and the first strain sensing element 142 is disposed on a first central line of symmetry L1 of the first surface S1 or a second central line of symmetry L2 of the second surface S2 while the second strain sensing element 144 is disposed on the first surface S1 or the second surface S2. Wherein the first central line of symmetry L1, for example, passes through the geometric center of the first surface S1 and the central point C of the central portion 110, and the second central line of symmetry L2, for example, passes through the geometric center of the second surface S2 and is parallel to the first central line of symmetry L1. In this embodiment, the second strain sensing element 144 is not disposed on the first central line of symmetry L1 or on the second central line of symmetry L2 of the second surface S2, but the disclosure is not limited thereto since the second strain sensing element 144 may be disposed on any position of the second surface S2. Therefore, the number of the sensing groups 140 is twice the number of the measurement shafts 130. However, in other embodiments, the number of the sensing groups 140 may be three or four times the number of the measurement shafts 130, and the disclosure is not limited thereto. For example, in this embodiment, the multi-axis force sensing device 100 has three measurement shafts 130 and six sensing groups 140, with three sensing groups A of the six sensing groups 140 disposed on the first surfaces S1 of the three measurement shafts 130 and three sensing groups B of the six sensing groups 140 disposed on the second surfaces S2 of the three measurement shafts 130 for six-axis force/torque measurement, but the disclosure is not limited thereto.

The first strain sensing element 142 and the second strain sensing element 144 are, for example, strain gauges, and the strain gauges is used to obtain the strain signals generated by mechanical arm 10 due to stress by using the Wheatstone bridge. In this embodiment, both the first strain sensing element 142 and the second strain sensing element 144 are semiconductor strain gauges, and the temperature characteristic of the first strain sensing element 142 is different from the temperature characteristic of the second strain sensing element 144. For example, the temperature coefficient of resistance of the first strain sensing element 142 is different from the temperature coefficient of resistance of the second strain sensing element 144, and/or the temperature coefficient of gauge factor of the first strain sensing element 142 is different from the temperature coefficient of gauge factor of the second strain sensing element 144, but the disclosure is not limited thereto.

In this embodiment, the first strain sensing element 142 and the second strain sensing element 144 are arranged, for example, in parallel, and between the first strain sensing element 142 and the second strain sensing element 144 is a spacing (both are not in contact). However, in different embodiments, the first strain sensing element 142 and the second strain sensing element 144 may be disposed closely without a spacing, and the disclosure is not limited thereto. For example, the first strain sensing element 142 and the second strain sensing element 144 are disposed in a direction perpendicular to the first central line of symmetry L1 or in a direction perpendicular to the second central line of symmetry L2. In other words, in this embodiment, the first surfaces S1 and the second surfaces S2 of the three measurement shafts 130 are all disposed with the first strain sensing elements 142 and the second strain sensing elements 144. The first strain sensing element 142 is disposed on the central line of symmetry on the surface, while the second strain sensing element 144 is disposed near the first strain sensing element 142 and keep a spacing between with the first strain sensing element 142, as shown in FIG. 3. Since the multi axis force sensing device 100 of this embodiment has the strain sensing elements disposed at different positions, therefore when the multi-axis force sensing device 100 performs measurements at different temperatures, calibration may be performed according to the measured strain signals measured by the strain sensing elements to compensate errors caused by temperature difference. In this way, the measurement results of the multi-axis force sensing device 100 of the embodiment may not be affected by temperature and may improve measurement accuracy, thereby improving the accuracy of the mechanical arm 10,

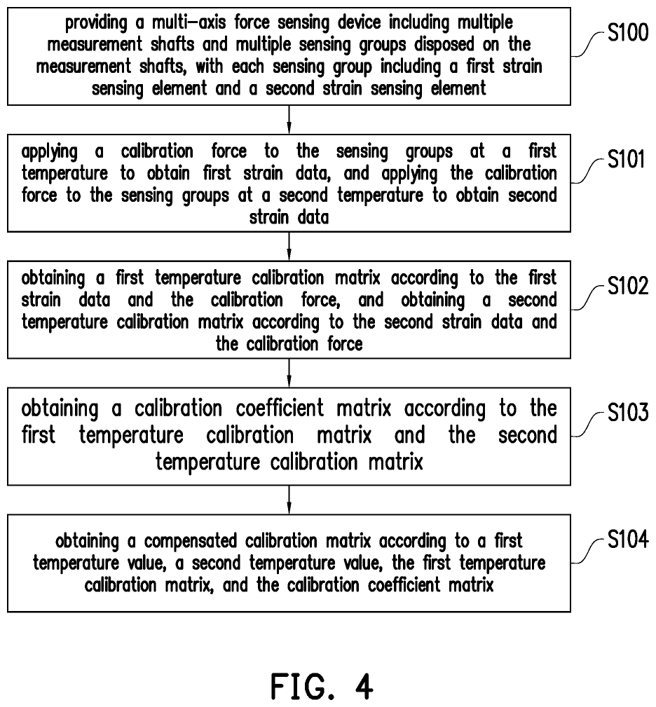

FIG. 4 is a flow chart of steps of a calibration method of a multi-axis force sensing device according to an embodiment of the disclosure. With reference to FIG. 1 to FIG. 4, this embodiment provides a calibration method of a multi-axis force sensing device that may be at least applied to the multi-axis force sensing device 100 shown in FIG. 1 to FIG. 3, so the following paragraphs take the application of the multi-axis force sensing device 100 shown in FIG. 1 to FIG. 3 as an example for description. In the calibration method of the multi-axis force sensing device of this embodiment, step S100 is performed first to provide the multi-axis force sensing device 100, and the multi-axis force sensing device 100 includes the measurement shafts 130 and the sensing groups 140 disposed on the measurement shafts 130, with each of the sensing groups 140 including a first strain sensing element 142 and a second strain sensing element 144.

Next, after the above step, step S101 is performed to apply a calibration force to the sensing groups 140 (apply the calibration force to the multi-axis force sensing device 100) at a first temperature to obtain first actual strain data and apply the calibration force to the sensing groups 140 at a second temperature to obtain second actual strain data. In this embodiment, the first temperature is a room temperature of 25 degrees, and the second temperature is 50 degrees. In detail, the Table 1 below shows the actual strain data respectively generated by the first strain sensing element 142 and the second strain sensing element 144 in each sensing group 140 at one temperature (e.g. the first temperature or the second temperature).

TABLE 1

| | cali- | | | | | | |
|---|---|---|---|---|---|---|---|
| | bration | | | | | | |
| shaft | force | 142A | 144A | 142B | 144B | 142C | 144C |
| Fx | 200N | 0 | 104 | 301 | 311 | 2 | −50 |
| Fy | 200N | 3 | 2 | −29 | −45 | −2 | −91 |
| Fz | 360N | 495 | 507 | −6 | −346 | 500 | 510 |
| Mx | 8 Nm | 754 | 770 | −13 | −531 | −374 | −391 |
| My | 8 Nm | 0 | −11 | −21 | −45 | −647 | −655 |
| Mz | 8 Nm | −1 | −170 | −490 | −504 | −1 | −167 |
| | cali- | | | | | | |
| | bration | | | | | | |
| shaft | force | 142D | 144D | 142E | 144E | 142F | 144F |
| Fx | 200N | −177 | −194 | −2 | −54 | −129 | −119 |
| Fy | 200N | −247 | −245 | −2 | 87 | 278 | 293 |
| Fz | 360N | −8 | −351 | 502 | 512 | −5 | −350 |
| Mx | 8 Nm | −11 | 224 | −375 | −372 | 24 | 303 |
| My | 8 Nm | 23 | 480 | 649 | 669 | 0 | −434 |
| Mz | 8 Nm | −486 | −497 | 1 | −166 | −492 | −503 |

In the above, 142A to 142F shown in Table 1 represent the first strain sensing elements in different sensing groups 140, and 144A to 144F represent the second strain sensing elements in different sensing groups 140, Fx, Fy, Fz, Mx, My and Mz represent the calibration force applied in different mode corresponding to six sensing axes of the multi-axis force sensing device 100, and the correction force represent as the force applied to the multi-axis force sensing device 100. As shown in Table 1 above, at the aforementioned temperature, the actual strains data received by the first strain sensing element 142 and the second strain sensing element 144 in each sensing group 140 are all different. In this step, a temperature sensor may be configured in the environment for temperature measurement to obtain temperature values of the aforementioned temperature (e.g, a first temperature value and a second temperature value). Or, obtain the temperature value according to the actual strain data, for example, measure at two temperatures, and obtain the first temperature value and the second temperature value according to the first actual strain data (measure at one temperature) and the second actual strain data (measure at another temperature) respectively, which may further resolve the problem of errors between temperatures measured by the temperature sensor disposed in the environment and the actual temperatures of the sensing groups 140, but the disclosure is not limited thereto.

Next, after the above step, step S102 is performed to obtain a first temperature calibration matrix according to the first actual strain data and the calibration force and obtain a second temperature calibration matrix according to the second actual strain data and the calibration force. In detail, after the step S101, the actual strain data in the above table 1 can be calculated by the following Formula (1) and take one of the roots to obtain the actual strain signal data as shown in Table 2 below; calculation may also be performed in the same way on the second actual strain data measured at the second temperature to obtain the actual strain signal data as shown in Table 3 below

$$e = \frac{- ( {GF}_{1} {α}_{2} - {GF}_{2} {α}_{1} + {A}_{2} {GF}_{1} {m}_{1} - {A}_{1} {GF}_{2} {m}_{2} )}{2 {GF}_{1} {GF}_{2} ( {m}_{2} - {m}_{1} )} \pm \frac{\sqrt{\begin{matrix}{( {GF}_{1} {α}_{2} - {GF}_{2} {α}_{1} + {A}_{2} {GF}_{1} {m}_{1} - {A}_{1} {GF}_{2} {m}_{2} )}^{2} - \\ 4 {GF}_{1} {GF}_{2} ( {m}_{2} - {m}_{1} ) ( {A}_{2} {α}_{1} - {A}_{1} {α}_{2} )\end{matrix}}}{2 {GF}_{1} {GF}_{2} ( {m}_{2} - {m}_{1} )} \qquad ( 1 )$$

where
ε is the actual strain signal;
A₁ is the change rate in resistance (i.e., the measured value) of the first strain sensing element;
A₂ is the change rate in resistance (i.e., the measured value) of the second strain sensing element;
GF₁ is the gauge factor of the first strain sensing element;
GF₂ is the gauge factor of the second strain sensing element;
m₁ is the temperature coefficient of gauge factor (TCGF) of the first strain sensing element;
m₂ is the temperature coefficient of gauge factor (TCGF) of the second strain sensing element;
α₁ is the temperature coefficient of resistance (TCR) of the first strain sensing element; and
α₂ is the temperature coefficient of resistance (TCR) of the second strain sensing element.

TABLE 2

| | cali- | | | | | | |
|---|---|---|---|---|---|---|---|
| | bration | | | | | | |
| shaft | force | 140A | 140B | 140C | 140D | 140E | 140F |
| Fx | 200N | −107.9 | 290.3 | 56.7 | −159.4 | 52.7 | −139.3 |
| Fy | 200N | 4.0 | −12.3 | 91.9 | −249.1 | −94.4 | 261.9 |
| Fz | 360N | 481.9 | 361.1 | 489.1 | 362.4 | 491.1 | 367.7 |
| Mx | 8 Nm | 736.1 | 556.8 | −356.7 | −252.1 | −378.0 | −262.0 |
| My | 8 Nm | 11.5 | 4.1 | −639.0 | −439.4 | 626.8 | 473.6 |
| Mz | 8 Nm | 178.5 | −475.9 | 175.3 | −474.9 | 178.4 | −480.9 |

TABLE 3

| | cali- | | | | | | |
|---|---|---|---|---|---|---|---|
| | bration | | | | | | |
| shaft | force | 140A | 140B | 140C | 140D | 140E | 140F |
| Fx | 200N | −94.6 | 291.6 | 49.8 | −161.6 | 45.8 | −137.1 |
| Fy | 200N | 3.9 | −14.4 | 80.1 | −248.8 | −83.0 | 264.0 |
| Fz | 360N | 483.6 | 313.5 | 490.5 | 314.3 | 492.5 | 319.3 |
| Mx | 8 Nm | 738.4 | 480.9 | −358.8 | −222.8 | −377.7 | −227.4 |
| My | 8 Nm | 10.1 | 1.0 | −640.0 | −384.2 | 629.7 | 411.2 |
| Mz | 8 Nm | 155.8 | −477.6 | 152.9 | −486.3 | 155.9 | −482.3 |

In the above, 140A to 140F shown in Table 2 and Table 3 represent the actual strain signal data of the sensing groups 140 disposed in different positions respectively at the first temperature and the second temperature after calculation by using Formula (1).

After Formula (1) excludes the influence of temperature, the values in Table 2 and Table 3 should be the same, yet there is still a slight difference in practice. Therefore, the actual strain signal data of Table 2 and Table 3 may respectively be calculated by using the following Formula (2) and Formula (3) to obtain the temperature calibration matrices at two different temperatures. In detail, in this step, the first actual strain signal data (Table 2) may be decoupled by the method of least squares to obtain the first temperature calibration matrix, and the second actual strain signal data (Table 3) may be decoupled by the method of least squares to obtain the second temperature calibration matrix. In this embodiment, the first temperature is 25 degrees Celsius, and the second temperature is 50 degrees Celsius for exemplification.

G_{25° C.}=F·U_{25° C.}^{T}·(U_{25° C.}·U_{25° C.}^{T})⁻¹ (2)

G_{50° C.}=F·U_{50° C.}^{T}·(U_{50° C.}·U_{50° C.}^{T})⁻¹ (3)
where
G_{25° C.} is the calibration matrix at the first temperature (first temperature calibration matrix);
G_{50° C.} is the calibration matrix at the second temperature (second temperature calibration matrix);
F is the matrix of the forces that the measurement shafts 130 are subject to;
U_{25° C.} is the actual strain signal matrix measured by the sensing groups 140 at the first temperature (e.g., table 2); and
U_{50° C.} is the actual strain signal matrix measured by the sensing groups 140 at e second temperature (e.g., table 3).

Next, after the above step, step S103 is performed to obtain a calibration coefficient according to the first temperature calibration matrix and the second temperature calibration matrix. For example, in this embodiment, after the calibration matrices at the first temperature and the second temperature (i.e., G_{25° C.} and G_{50° C.}) are obtained, the calibration coefficient matrix is obtained by interpolating according to the first temperature calibration matrix, the second temperature calibration matrix, the first temperature, and the second temperature.

Next, after the above step, step S104 is performed to obtain a compensated calibration matrix according to the first temperature value, the second temperature value; the first temperature calibration matrix, and the calibration coefficient matrix. For example, in this embodiment; after the calibration coefficient matrix is obtained, calculation may be performed by using the following Formula (4) to obtain a compensated calibration matrix.

[G_{compensated}]_{6×6}=[G_{25° C.}]_{6×6}+[k]_{6×6}×ΔT (4)
where
G_{compensated} is the compensated calibration matrix;
G_{25° C.} is the calibration matrix at the first temperature (first temperature calibration matrix);
[k]_{6×6} is the calibration coefficient matrix; and
ΔT is the difference between the first temperature and the second temperature.

Therefore, with the compensated calibration matrix, the following Formula (5) may be used to calculate the actual strain signal data measured at different temperatures to obtain force data.

F=G_{compensated}·U (5)
where
G_{compensated} is the compensated calibration matrix;
U is the actual strain signal matrix.

In this way, using the calibration method provided in the embodiments of the disclosure may effectively compensate and correct the semiconductor strain gauge; such that the multi-axis force sensing device 100 may avoid the problem of temperature drift generated by the influence of temperature, thereby improving the accuracy of force measurement.

In summary, in the multi-axis force sensing device and the calibration method thereof in the disclosure, the multi-axis force sensing device includes the measurement shafts and the sensing groups disposed on the measurement shafts, and each sensing group includes the first strain sensing element and the second strain sensing element disposed at different positions. The calibration matrices in different temperatures are obtained by calculating with strain data and force data measured in different temperatures. The calibration coefficient is obtained by interpolating with the calibration matrices in different temperatures and the measured temperatures. Moreover, the compensated calibration matrix is obtained by calculating with the calibration matrices in different temperatures and the calibration coefficient. In this way, putting the compensated calibration matrix into the formula for calibration matrix calculation may effectively compensate and correct signal data of the semiconductor strain gauge, such that the multi-axis force sensing device may avoid the problem of temperature drift generated by the influence of temperature, thereby improving the accuracy of force measurement.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention,” “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A multi-axis force sensing device, comprising:
a central portion;
an outer ring portion, surrounding the central portion;
a plurality of measurement shafts, respectively connected between the central portion and the outer ring portion, the measurement shafts equally disposed on an outer side of the central portion; and
a plurality of sensing groups, a first surface and a second surface of each of the sensing groups respectively disposed with one of the measurement shafts, and each of the sensing groups comprising:
a first strain sensing element, disposed on a first central line of symmetry of the first surface or a second central line of symmetry of the second surface; and
a second strain sensing element, disposed on the first surface or the second surface.

2. The multi-axis force sensing device according to claim 1, wherein the first surface of each of the measurement shafts is perpendicular to the second surface.

3. The multi-axis force sensing device according to claim 1, wherein the first strain sensing element and the second strain sensing element of each of the sensing groups are arranged in a direction perpendicular to the first central line of symmetry or in a direction perpendicular to the second central line of symmetry.

4. The multi-axis force sensing device according to claim 1, wherein the first strain sensing element and the second strain sensing element of each of the sensing groups are semiconductor strain gauges.

5. The multi-axis force sensing device according to claim 1, wherein a number of the measurement shafts is at least three, and the measurement shafts surround the central portion with a central point of the central portion as a center of symmetry.

6. The multi-axis force sensing device according to claim 1, wherein a temperature coefficient of resistance of the first strain sensing element is different from a temperatu coefficient of resistance of the second strain sensing element, and/or a temperature coefficient of gauge factor of the first strain sensing element is different from a temperature coefficient of gauge factor of the second strain sensing element.

7. A calibration method of a multi-axis force sensing device, comprising:
providing a multi-axis force sensing device, wherein the multi-axis force sensing device comprises a plurality of measurement shafts and a plurality of sensing groups disposed on the measurement shafts, and each of the sensing groups comprises a first strain sensing element and a second strain sensing element;
applying a calibration force to the sensing groups at a first temperature to obtain first actual strain data, and applying the calibration force to the sensing groups at a second temperature to obtain second actual strain data;
obtaining a first temperature calibration matrix according to the first actual strain data and the calibration force, and obtaining a second temperature calibration matrix according to the second actual strain data and the calibration force;
obtaining a calibration coefficient matrix according to the first temperature calibration matrix and the second temperature calibration matrix; and
obtaining a compensated calibration matrix according to a first temperature value, a second temperature value, the first temperature calibration matrix, and the calibration coefficient matrix.

8. The calibration method of the multi-axis force sensing device according to claim 7, wherein applying the calibration force to the sensing groups at the first temperature to obtain the first actual strain data and applying the calibration force to the sensing groups at the second temperature to obtain the second actual strain data further comprise:
measuring the first temperature to obtain the first temperature value; and
measuring the second temperature to obtain the second temperature value.

9. The calibration method of the multi-axis force sensing device according to claim 7, wherein applying the calibration force to the sensing groups at the first temperature to obtain the first actual strain data and applying the calibration force to the sensing groups at the second temperature to obtain the second actual strain data further comprise:
obtaining the first temperature value and the second temperature value according to the first actual strain data and the second actual strain data.

10. The calibration method of the multi-axis force sensing device according to claim 7, wherein obtaining the first temperature calibration matrix according to the first actual strain data and obtaining the second temperature calibration matrix according to the second actual strain data further comprise:
decoupling the first actual strain data by a method of least squares to obtain the first temperature calibration matrix; and
decoupling the second actual strain data by the method of least squares to obtain the second temperature calibration matrix.
